(19) United States
(12) Patent Application Publication
(10) Pub. No.: US 2026/0163623 A1
(43) Pub. Date: Jun. 11, 2026

(54) METHODS FOR CSI REPORTING WITH LP-WUS

(71) Applicant: InterDigital Patent Holdings, Inc., Wilmington, PA (US)

(72) Inventors: Samuli Turtinen, Ii (FI); Young Woo Kwak, Woodbury, NY (US); Nazli Khan Beigi, Longueuil (CA); Prasanna Herath, Laval (CA); Moon IL Lee, Melville, NY (US)

(73) Assignee: InterDigital Patent Holdings, Inc., Wilmington, DE (US)

(21) Appl. No.: 18/972,296

(22) Filed: Dec. 6, 2024

(51) Int. Cl. H04B 7/06; H04B 17/318; H04W 24/10; H04W 52/02

(52) U.S. Cl. CPC H04B 7/0626; H04B 17/328; H04W 24/10; H04W 52/0235

(57) ABSTRACT

A wireless transmit/receive unit (WTRU) is configured to receive channel state information (CSI) measurement and reporting configuration information and low power wake-up signal (LP-WUS) configuration information. The CSI measurement and reporting configuration information may indicate a CSI reporting occasion. The LP-WUS configuration information may indicate LP-WUS monitoring occasions (MOs). The WTRU is configured to decode a LP-WUS, using a low power wake-up receiver (LR), in a LP-WUS MO, perform measurements on a reference signal using the LR, determine that CSI information, based on a main radio measurement, is not to be reported in the CSI reporting occasion. The WTRU may determine that CSI information is not to be reported based on a relationship of one or more time offsets to one or more events. The WTRU is configured to send a CSI report in the CSI reporting occasion, based on the measurements on the reference signal using the LR.

### BACKGROUND

A wireless transmit/receive unit (WTRU) may monitor and receive a wake-up signal (WUS) via a first radio (e.g., a low-power or ultra-low power radio). The WUS may be referred to as a low-power WUS (LP-WUS). The first radio may be referred to as a low-power radio (LR) or a low power wake-up radio (LP-WUR). A received WUS (e.g., an LP-WUS), for example via a LR, may trigger wake-up or use of a second radio of the WTRU (e.g., the WTRU's main radio (MR)) for data and/or control signal transmission and/or reception. This has the potential to reduce the power consumption of wireless devices.

### SUMMARY

A wireless transmit/receive unit (WTRU) may be configured to perform channel state information (CSI) reporting. The WTRU may be configured to receive configuration information. The configuration information may comprise CSI measurement and reporting configuration information and low power wake-up signal (LP-WUS) configuration information. The CSI measurement and reporting configuration information may indicate a CSI reporting occasion. The LP-WUS configuration information may indicate LP-WUS monitoring occasions (MOs). The WTRU may receive the configuration information via a main radio receiver (MR). The WTRU may be configured to receive and decode a LP-WUS, using a low power wake-up receiver (LR), in a LP-WUS MO. The WTRU may be configured to perform measurements on a reference signal using the LR. The WTRU may be configured to determine that CSI information, based on a main radio (MR) measurement, is not to be reported in the CSI reporting occasion. The determination may be based on a relationship of one or more time offsets to one or more events. The WTRU may be configured to send a CSI report in the CSI reporting occasion, based on the measurements on the reference signal using the LR. The WTRU may be in an active time. The one or more events may comprise a time of the CSI reporting occasion and a time of the LP-WUS MO. The determination that CSI information, based on a main radio (MR) measurement, is not to be reported in a CSI reporting occasion may be based on a time between the time of the CSI reporting occasion and the time of the LP-WUS MO being less than a first time offset value. The one or more events may comprise a time of a CSI measurement RS and a time of the LP-WUS MO. The determination that CSI information is not to be reported, based on a main radio (MR) measurement, in a CSI reporting occasion may be based on a time between the time of the CSI measurement RS and the time of the LP-WUS MO being less than a second time offset value. The one or more events may comprise a time of a CSI measurement RS and a time of the CSI reporting occasion. The determination that CSI information, based on a main radio (MR) measurement, is not to be reported in a CSI reporting occasion may be based on a time between the time of the CSI reporting occasion and the time of the CSI measurement RS being less than a third time offset value. The WTRU may be configured to send subsequent CSI reports, based on LR measurements, until the WTRU measures CSI information with the MR and is ready to report CSI information, based on MR measurements. The WTRU may be configured to send an indication that the CSI report is based on LR measurements. The CSI report, based on the measurements on the reference signal using the LR, may comprise a subset of parameters of MR CSI parameters, wherein the CSI report, based on the measurements on the reference signal using the LR, may comprise at least a layer 1 reference signal received power (L1-RSRP). The L1-RSRP parameter may be based on a most recent LR measurement and other parameters in the LR CSI report are based on outdated measurements. The outdated measurement may be based on previous MR measurements. The sending the CSI report, based on the measurements on the reference signal using the LR, may be based on an expiration of a CSI validity timer. The sending the CSI report, based on the measurements on the reference signal using the LR, may be based on results of LR measurements changing less than a threshold amount during a sleep cycle of the MR or since a previous CSI report or since a previous CSI measurement with the MR.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of a simplified receiver architecture of a WTRU utilizing a low-power wake-up receiver;

FIG. 3 shows an example of LP-WUS Option 1-1 operation and CSI reporting;

FIG. 4 shows an example of LP-WUS Option 1-2 operation and CSI reporting;

FIG. 5 shows an example of LP-WUS monitoring and CSI reporting;

FIG. 6 shows an example procedure for CSI reporting;

FIG. 7 shows an example procedure for CSI reporting; and

FIG. 8 shows an example configuration of 1^{st} and 2^{nd} type on durations and 1^{st} and 2^{nd} type LP-WUS MOs.

### DETAILED DESCRIPTION

The following abbreviations and acronyms may be referred to:
C-DRX Connected mode DRX
CQI Channel Quality Information
CRI CSI-RS Resource Indicator
CSI Channel State Information
DCI Downlink Control Information
DL Downlink
DRX Discontinuous Reception
LI Layer Indicator
LP Low Power
LR Low Power Radio
MO Monitoring Occasion
MR Main Radio
MAC Medium Access Control
NW Network
PBCH Physical Broadcast Channel
PMI Precoding Matrix Indicator
PDCCH Physical Downlink Control Channel
PUCCH Physical Uplink Control Channel
PDSCH Physical Downlink Shared Channel
PUSCH Physical Uplink Shared Channel
RI Rank Indicator
RRM Radio Resource Management
RS Reference Signal
RSRP Reference Signal Received Power
SRS Sounding Reference Signal
SS Synchronization Signal
SSBRI SS/PBCH Resource Block Indicator
UL Uplink
WUR Wake up Radio
WUS Wake up Signal

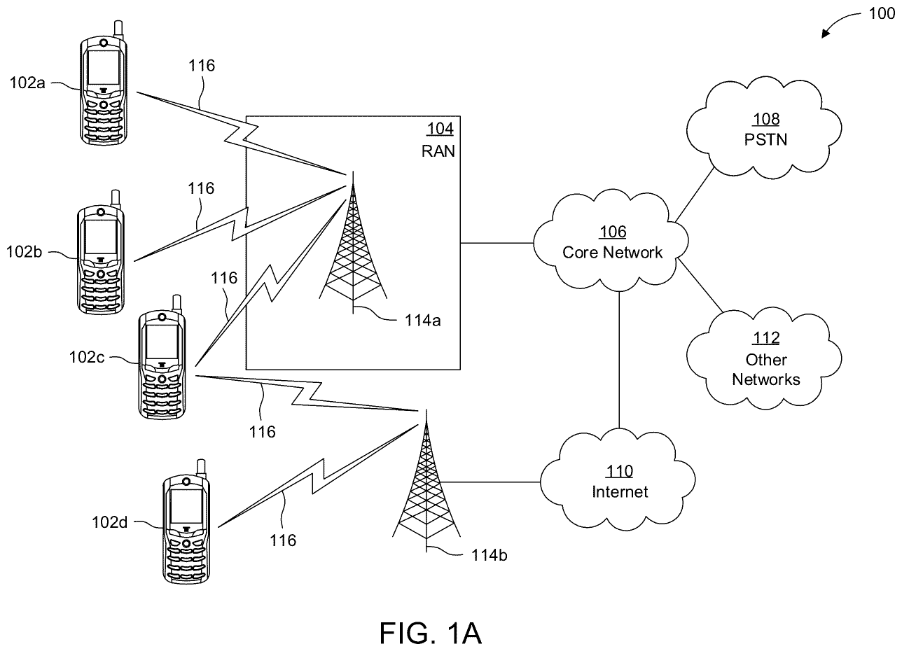

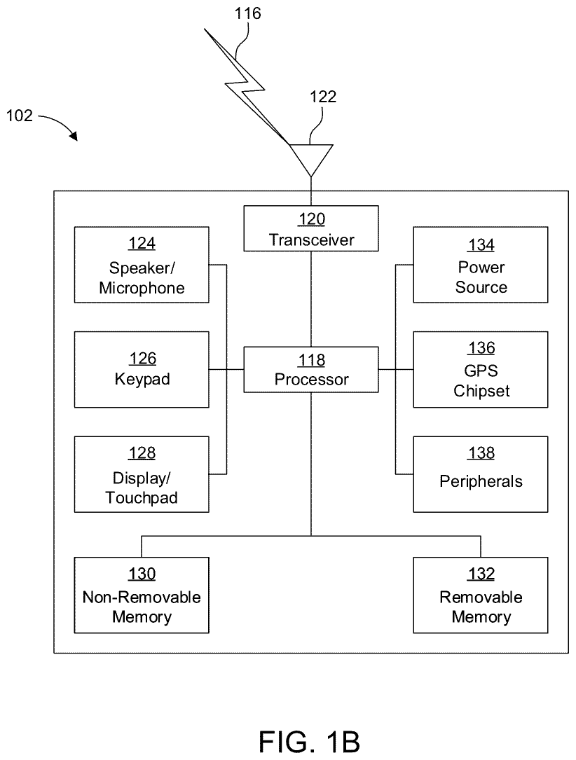

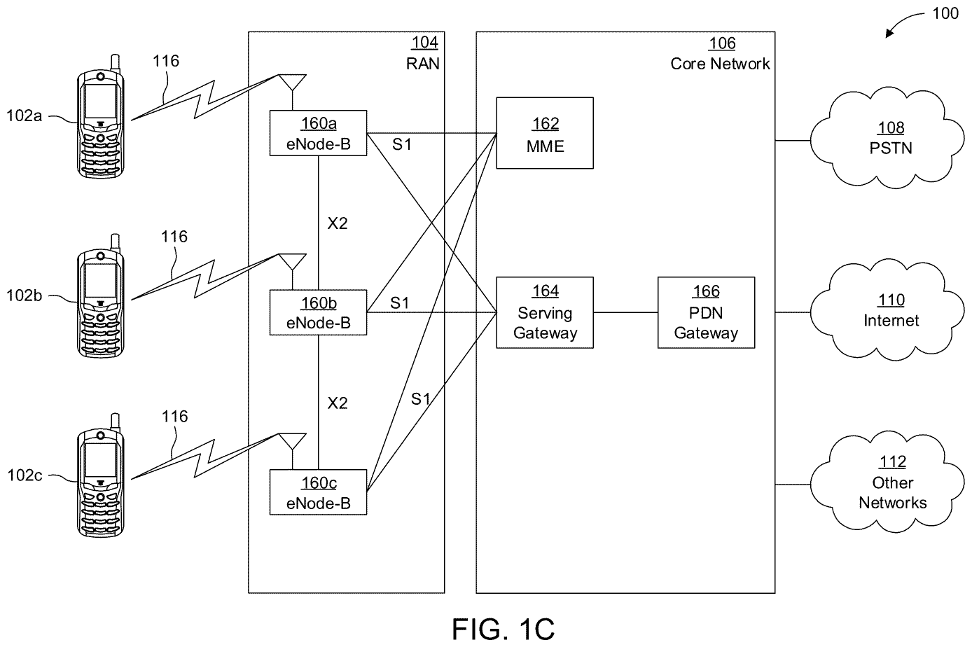

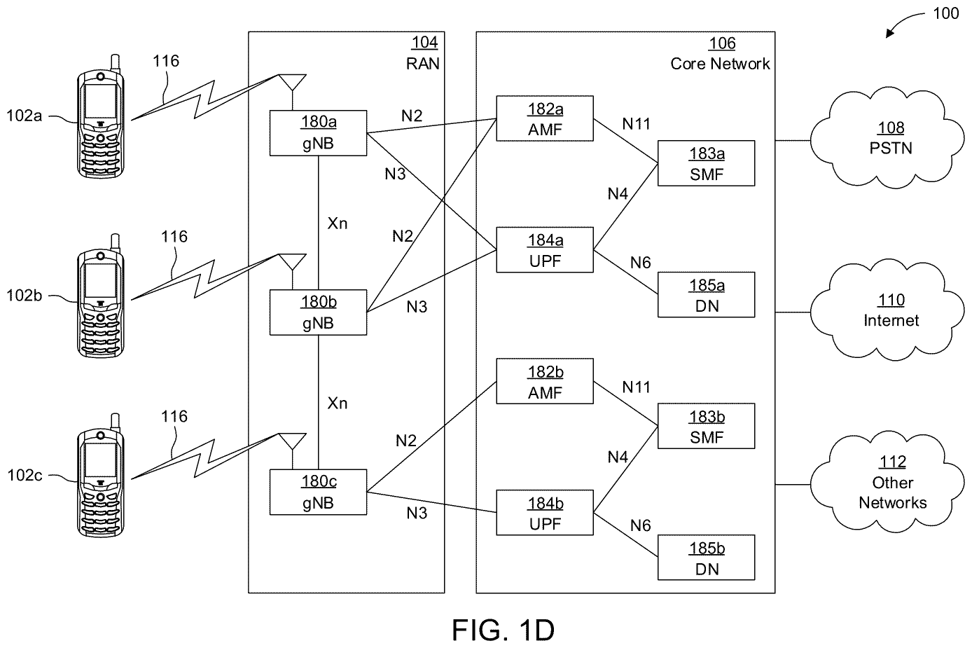

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114 b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, 6G etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11 z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182 a, 182 b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

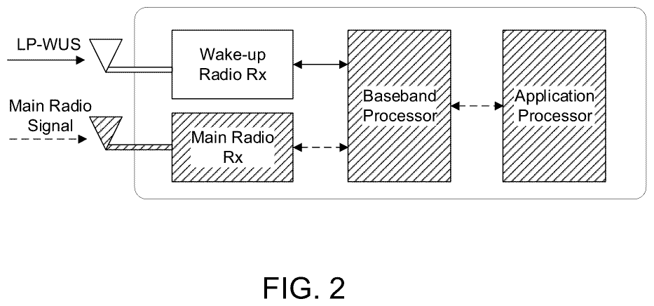

FIG. 2 shows an example of a simplified receiver architecture of a WTRU utilizing a low-power wake-up receiver. The WTRU may comprise a low power wake-up radio (LR) receiver, a main radio (MR) receiver, a baseband processor, and an application processor. A low power wake-up signal (LP-WUS) may be received via the LR receiver. A main radio signal may be received via the MR receiver. It should be understood the example shown in FIG. 2 of a simplified receiver architecture of a WRTU utilizing a low-power wake-up receiver is a mere example and an architecture where the LR receiver and the MR receiver are implemented by a single receiver may also be supported in some implementations.

Low power wake-up signal (LP-WUS) option 1-1 and 1-2 have been agreed by 3GPP RAN 1 . A working assumption is that from the RAN1 perspective, for RRC CONNECTED mode, PDCCH monitoring is triggered by a LP-WUS with C-DRX configuration. Support Option 1-1 includes LP-WUS monitoring according to the LP-WUS monitoring configuration before a drx-onDurationTimer to trigger the starting of the drx-onDurationTimer. Support Option 1-2 includes LP-WUS monitoring outside at least legacy C-DRX active time according to the LP-WUS monitoring configuration to trigger PDCCH monitoring. Both options 1-1 and 1-2 are configured with a DRX configuration for a WTRU in RRC_CONNECTED mode (for Option 1-2 mainly for the CSI reporting during drx-onDurationTimer occasions). However, it should be understood not always the DRX configuration may be required with some of the LP-WUS options (like option 1-2), for example, with 6G radio.

RAN1 has agreed to a CSI framework for Option 1-1 and Option 1-2.

For Option 1-1 of a LP-WUS CONNECTED mode operation, the followings are assumed from RAN1 perspective. LP-WUS monitoring according to the LP-WUS monitoring configuration before drx-onDurationTimer to trigger the starting of the drx-onDurationTimer. A WTRU is configured with legacy C-DRX configurations as in Release 18. WTRU behaviors related to CDRX active time triggered by all legacy DRX timers are not affected unless included in this proposal. No impact on RRM/RLM/BFD measurement requirements is assumed For periodic CSI/L1-RSRP reporting, a WTRU may be configured with one of the following (same as Rel-16 DCP):
Periodic CSI/L1-RSRP is not reported during the time given by the configured drx-onDurationTimer if the WTRU is not indicated to wake-up; Periodic CSI/L1-RSRP is periodically reported during the time given by the configured drx-onDurationTimer regardless if a WTRU is indicated to wake-up or not. Periodic CSI/L1-RSRP is reported during CDRX active time as in legacy specification.

For option 1-2 of LP-WUS CONNECTED mode operation, the followings are assumed from RAN1 perspective.

LP-WUS monitoring outside at least C-DRX active time according to the LP-WUS monitoring configuration to trigger PDCCH monitoring. A WTRU may be configured with C-DRX configurations. A WTRU is expected to be configured with LP-WUS monitoring configuration (periodicity and offset may be different from those from C-DRX configuration). Potential restrictions for LP-WUS configuration in relation with C-DRX configuration is an open issue. A LP-WUS triggers the start of a timer during which the WTRU monitors PDCCH. The timer may be a new timer. WTRU PDCCH monitoring behaviors related to other legacy DRX timers are not affected (e.g. drx-InactivityTimer, drx-RetransmissionTimerDL, drx-RetransmissionTimerUL, drx-HARQ-RTT-TimerDL, drx-HARQ-RTT-TimerUL). No impact on RRM/RLM/BFD measurement requirements is assumed. For periodic CSI/L1-RSRP reporting, a WTRU may be configured with one of the following (same as Rel-16 DCP and option 1-1): Periodic CSI/L1-RSRP is not reported if a WTRU is not indicated to wake-up; Periodic CSI/L1-RSRP is periodically reported regardless if a WTRU is indicated to wake-up or not. WTRU PDCCH monitoring is not triggered by legacy C-DRX cycle and drx-onDurationTimer when monitoring LP-WUS.

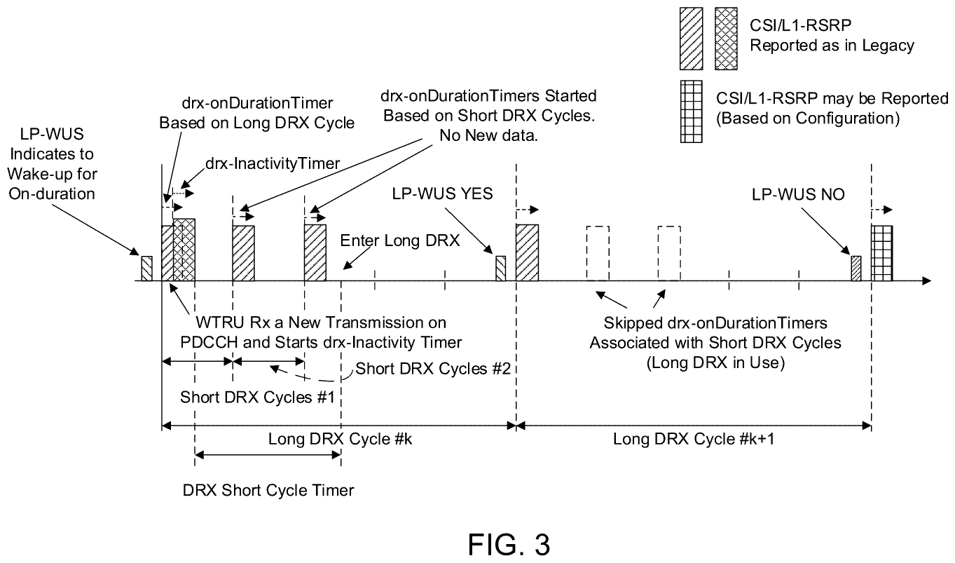

FIG. 3 shows an example of LP-WUS Option 1-1 operation and CSI reporting. CSI/SRS is reported during drx-onDurationTimer occasions and drx-InactivityTimer when running (i.e., WTRU is in active time). Periodic/semi-persistent CSI/SRS is not reported while outside active time. Aperiodic CSI/SRS is reported if issued by the network (NW). Periodic SRS and semi-persistent CSI/SRS is not reported during drx-onDurationTimer occasions when a LP-WUS does not wake-up the WTRU for on duration. Periodic CSI may be reported during drx-onDurationTimer occasions when a LP-WUS does not wake-up the WTRU for on duration. This depends on NW configuration. CSI may comprise an L1-RSRP or other periodic CSI in this case. It is still for further study regarding whether LP-WUS may be used for a Short DRX cycle as well but in those occasions a WTRU would perform CSI reporting also as above. In FIG. 3, the drx-onDurationTimer is started for Short DRX cycle(s) without a LP-WUS.

If a WTRU multiplexes a CSI configured on PUCCH with other overlapping UCI(s) according to the procedure specified in TS 38.213 clause 9.2.5 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to WTRU implementation whether to report this CSI multiplexed with other UCI(s).

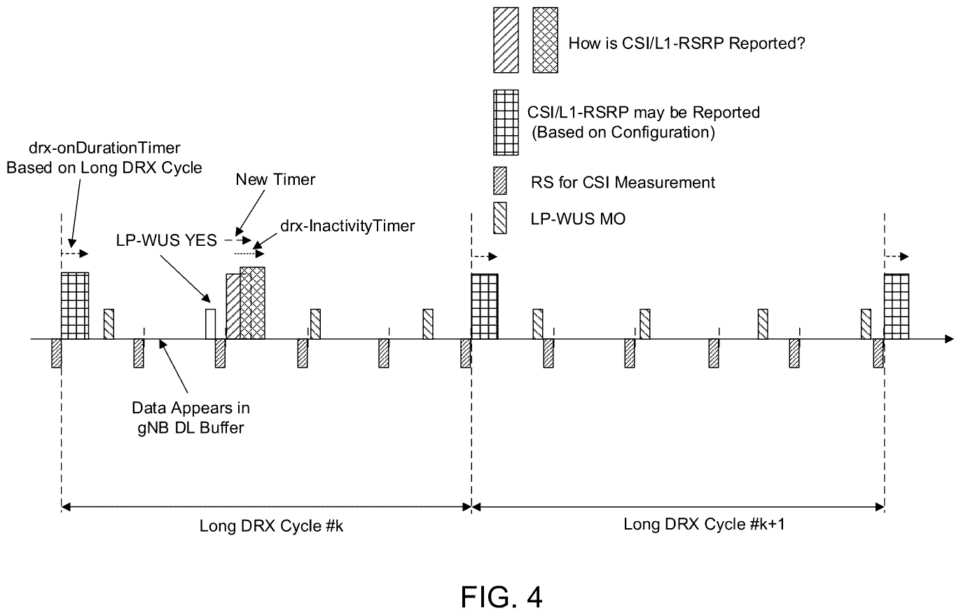

A benefit of Option 1-2 compared to Option 1-1 is that the periodicity of LP-WUS monitoring occasions (MOs) may be configured more frequently than with Option 1-1 to allow waking up a WTRU in arbitrary times during the DRX cycle. The CSI reporting may be configured similarly to Option 1-1 (. i.e., during drx-onDurationTimer occasions), as shown in FIG. 4. In FIG. 4, the LP-WUS MO periodicity is not aligned with DRX cycle periodicity (i.e., not being a multiple of it). The reference signal (RS) for CSI measurements is an example and may in occasions overlap with a LP-WUS MO or precede an on-duration occasion. Short DRX cycle on-duration occasions are possible (dashed box extending from the start of the New Timer into the drx-InactivityTimer in FIG. 4), however, there is a question on whether Short DRX may be configured with Option 1-2. A WTRU may be configured to report periodic CSI during the drx-onDurationTimer occasions while the timer is not running. Generally, the drx-onDurationTimer may not run (or start) with Option 1-2. This may depend on NW configuration. CSI may comprise an L1-RSRP or other periodic CSI in this case. However, when data appears in the downlink (DL) in the middle of DRX and a gNB wants to wake up the WTRU with a LP-WUS in one of the LP-WUS occasions (i.e. LP-WUS YES in FIG. 4), the WTRU may need to measure and be prepared to report CSI after each LP-WUS MO, in case a LP-WUS wakes-up the WTRU in the middle of DRX. The more the WTRU needs to measure, the more the MR needs to be on and the more WTRU power consumption is used. The NW may configure shorter DRX cycle to get a CSI more frequently but that also affects WTRU power consumption.

An issue is how to facilitate the WTRU measurements for CSI reporting while in DRX with Option 1-2 LP-WUS not to compromise the WTRU battery life too much compared to Option 1-1, and what to report in the CSI report during active times defined by a new timer. It is assumed that CSI reporting during active times (e.g., when the “new timer” is running) is performed by WTRU as in legacy procedures.

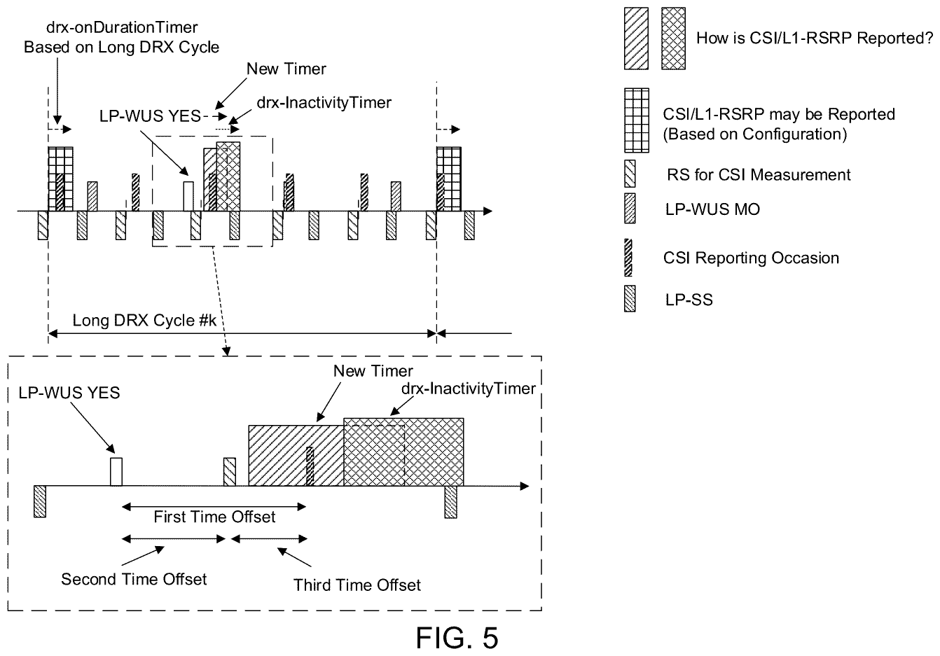

FIG. 5 shows an example of LP-WUS monitoring and CSI reporting in accordance with one or more embodiments. A WTRU may be enabled to measure and/or report CSI more infrequently or report outdated CSI or report a subset of CSI (e.g., by means of LR measurements) to facilitate the MR measurement activity and, hence, reduce WTRU power consumption during LP-WUS monitoring.

A WTRU may be configured at least with a LP-WUS configuration (e.g. as in option 1-2), and CSI measurement and reporting configuration. The WTRU may additionally be configured with a DRX configuration.

The WTRU MR may be in a DRX/sleep mode and a LR may decode a LP-WUS signal based on a LP-WUS monitoring configuration.

The WTRU may be configured to (e.g. required to) perform one or more of the following.

The WTRU may perform LR measurements on a reference signal (RS) (e.g., on a LP-SS) while the WTRU is not in active time and the MR is in a sleep state.

The WTRU may be configured with a CSI measurement RS configuration that precedes the CSI reporting occasion before or while a new timer for active time is ongoing or running.

The CSI measurement RS configuration may precede the CSI reporting occasion if the CSI reporting occasion is a first time offset after the LP-WUS occasion.

In an embodiment, the CSI measurement RS may be provided (e.g. always provided) a second time offset after the LP-WUS occasion. In an embodiment, the CSI may not be reported based on this CSI measurement RS in the CSI reporting occasion if the CSI reporting occasion is not at least a third time offset after the CSI measurement RS occasion. In an embodiment, the CSI may be reported based on this CSI measurement RS in the CSI reporting occasion if the CSI reporting occasion is at least a third time offset after the CSI measurement RS occasion.

In an embodiment the LP-WUS offset (to the new timer start) may be configured such that it accounts for a WTRU maximum wake-up time before the CSI measurement RS so that the WTRU may be able to measure with the MR before the new timer defined active time. In one example, this may depend on a WTRU capability to be able to provide “one-shot” CSI measurement results.

In an embodiment, only a subset of the CSI report may be measured and reported based on this CSI measurement RS (e.g., dependent on the processing time, only a subset is reported, and other CSI may be indicated as “out of range”/“outdated”).

In an embodiment, one or more of the first, second and third time offsets may be indicated by the WTRU as WTRU capability to the network.

In an embodiment, in a scenario where the CSI cannot be reported in the CSI reporting occasion (e.g., if one or more of the time offset conditions are not fulfilled as defined above), the LR performed measurements may be reported in the CSI reporting occasion when the new timer is started and the WTRU is in active time.

In an embodiment, the LR measurements may be reported until the MR has performed measurements and is ready to report CSI information.

In an embodiment, the WTRU may indicate, in the CSI report, that the results are based on LR measurements. In an embodiment, the network may determine that the measurement results are based on LR measurements based on, for example the WTRU indicated capability(ies) for the one or more of the first, second, and third offsets.

In an embodiment, the LR measurements may comprise of a subset of MR measured CSI information (e.g., L1-RSRP only and/or SINR).

In an embodiment, the WTRU may indicate “outdated”/“out of range” CSI or use “outdated” measurements (e.g., previous measurement with the MR) for other CSI but L1-RSRP which may be reported based on the latest LR based measurements.

In an embodiment, the LR measurements may be reported in the CSI report only if the MR measurements are “too old” (e.g., based on a “CSI validity timer”) and/or if the LR measurement results did not change more than a threshold amount (e.g., in terms of RSRP/RSRQ/SINR) during the MR sleep/since the previous CSI report/since the previous CSI measurement with the MR.

In an embodiment, since the WTRU wake up time may be different dependent on the “sleep state” of the MR, the WTRU may report whether the CSI measurement with the MR was performed or not. In one example, this indication may be the same as the above indication of reporting LR based measurements in the CSI report.

While the new timer is running, the WTRU may determine/compile/construct and transmit, at least part of, the CSI in the CSI reporting occasion.

By accepting less accurate CSI or a subset of CSI, the WTRU power consumption during the LP-WUS monitoring period may be reduced before data activity, as compared with LP-WUS Option 1-1.

LR measurements, which are performed during LP-WUS monitoring, may be exploited for rough CSI reporting requiring less MR activity during a LP-WUS monitoring period.

The network may need to perform more conservative scheduling decisions for the WTRU than required due to less accurate CSI in the beginning of the new timer, however, the scheduling flexibility may be better enforced as compared to Option 1-1 LP-WUS with comparable WTRU power consumption.

A WTRU may receive one or more configurations (e.g. pre-configured or receive configuration information) related to LP-WUS, DRX, and CSI measurement and reporting configuration. In an embodiment, a WTRU may be configured (e.g. pre-configured or receive configuration information) with one or more of the following.

The WTRU may be configured with a LP-WUS configuration (e.g. option 1-2 where LP-WUS indicates to start a timer and does not start an drx-onDurationTimer) which may include, for example, a monitoring configuration; a subgroup ID; a time offset to the timer (i.e. new timer) start.

The WTRU may be configured with a DRX configuration which may include, for example, a drx-onDurationTimer: the duration at the beginning of a DRX cycle; a drx-SlotOffset: the delay before starting the drx-onDurationTimer; a drx-InactivityTimer: the duration after the PDCCH occasion in which a PDCCH indicates a new UL, DL or SL transmission for the MAC entity; a drx-RetransmissionTimerDL (per DL HARQ process except for the broadcast process): the maximum duration until a DL retransmission is received; a drx-RetransmissionTimerUL (per UL HARQ process): the maximum duration until a grant for UL retransmission is received; a drx-LongCycleStartOffset: the Long DRX cycle and drx-StartOffset which defines the subframe where the Long and Short DRX cycle starts; a drx-HARQ-RTT-TimerDL (per DL HARQ process except for the broadcast process): the minimum duration before a DL assignment for HARQ retransmission is expected by the MAC entity; and a drx-HARQ-RTT-TimerUL (per UL HARQ process): the minimum duration before a UL HARQ retransmission grant is expected by the MAC entity.

The WTRU may be configured with a CSI measurement and reporting configuration. The CSI measurement and reporting configuration may include an indication of a resource. The resource parameter may define the physical location (i.e., the location of a physical resource element) of the various CSI related reference signal. Types of the resources belonging to this category include: non-zero power (NZP)-CSI-RS resource, zero power (ZP)-CSI-RS resource, and interference management (IM) Resources. The CSI measurement and reporting configuration may include a resource set (ResourceSet). The Resource parameter may be an individual resources. The individual resources may belong to a specific group. If only one resource is to be used, it still may belong to a group. The group may be referred to as a ResourceSet. The CSI measurement and reporting configuration may include a CSI resource configuration (ResourceConfig), which may specify on what type of reference signal (e.g. NSP-CSI-RS-SSB, CSI-IM-Resource) is to be transmitted. It may also configure the types of the transmission (e.g. periodic, aperiodic, semipersistent). The CSI measurement and reporting configuration may include a CSI report configuration (ReportConfig), which may specify which CSI ResourceConfig is to be used for the measurement, which may be the mapping table between the measurement type and the corresponding CSI ResourceConfig ID. The CSI measurement and reporting configuration may include a periodicity and offset (CSI-ReportPeriodicityAndOffset), which may define the CSI reporting periodicity in number of slots and offset to determine the actual slot to transmit the report.

A WTRU may be in a MR-ON mode or an MR-OFF modes.

A WTRU may use a (e.g., separate) low power-wake up receiver (LP-WUR) which may be used to monitor low-power wake-up signals (LP-WUS) and trigger and/or wake-up a Main radio Receiver (MR) dedicated for data and control signal transmission and/or reception. The WTRU may be configured with one or more modes of operation, for example, in systems based on LP-WUS. In an example, the WTRU may be configured with an MR-ON mode and an MR-OFF mode. The WTRU may alternate and/or switch between operating in an MR-ON mode and an MR-OFF mode. In an example, the WTRU may save power being in an MR-OFF mode. In another example, the WTRU may enter an MR-ON mode upon receiving an LP-WUS.

The WTRU in an MR-ON mode may turn on the MR and use the MR to send and/or receive channel transmissions or signals, for example, to and/or from a Node-B or base station. The WTRU in an MR-ON mode may monitor, detect, receive and/or measure one or more reference signals, for example, a SSB, CSI-RS, PT-RS, or DR-RS.

The WTRU in an MR-OFF mode may turn off the MR and may use the LP-WUR to receive one or more low-power signals, or channel transmissions. For example, the WTRU in an MR-OFF mode may monitor, detect, receive and/or measure one or more Low-Power Synchronization Signals (LP-SS) and/or a LP-WUS. During an MR-OFF mode, the WTRU may monitor to receive and/or detect one or more configured LP-WUS and may wake up the MR and switch to an MR-ON mode upon reception of at least one LP-WUS.

The WTRU in an MR-OFF mode, for example, may use the LP-WUR to monitor the LP-SS signal to obtain necessary synchronization. In an example, a WTRU in an RRC-Idle and/or RRC-Inactive state in an MR-OFF mode may need to switch to n MR-ON mode and to wake up the MR after receiving and/or detecting a LP-WUS. After waking up the MR and switching to an MR-ON mode, the WTRU may monitor one or more paging occasions (PO), for example, to receive paging messages. After receiving the paging message and based on the received paging message, the WTRU may switch to an RRC-Connected state, and transmit and/or receive one or more indicated signals and/or channel transmissions. After transmitting and/or receiving the indicated signals and/or channel transmissions, the WTRU may turn off the MR and switch back to an MR-OFF mode. In an example, a WTRU in an RRC-Connected state in an MR-OFF mode may switch to an MR-ON mode and to wake up the MR after receiving and/or detecting a LP-WUS. After waking up the MR and switching to n MR-ON mode, the WTRU may monitor to receive a PDCCH in one or more configured CORESETs (control channel resource sets) and/or CSS (common search space). The received PDCCH may include grant indications for one or more UL and/or DL transmissions and/or receptions. In an example, the WTRU in an MR-ON mode may be configured to transmit on or more CSI reports. After transmitting and/or receiving based on the configurations and/or indicated grant indication, the WTRU may turn off the MR and switch back to an MR-OFF mode.

It should be understood that the embodiments as described herein may be applied in isolation, or together, or concurrently. For example, one embodiment may depend on conditions of another embodiment.

In an example, a WTRU may be configured with a CSI measurement RS configuration. The configuration may include parameters, for example as discussed above (e.g. Resource, ResourceSet, CSI ResourceConfig, CSI ReportConfig, CSI ReportPeriodicityAndOffset). The CSI measurement RS configuration, or at least part of it, (e.g., periodicity) may follow a LP-WUS monitoring configuration (e.g. periodicity). Alternatively, or in addition, the CSI measurement RS configuration may be part of the LP-WUS monitoring configuration or the LP-WUS monitoring configuration may point to a specific CSI measurement RS configuration (e.g., through an identification (ID), such as CSI ResourceConfig ID).

In an example, the CSI measurement RS may follow a time offset after the LP-WUS MO (Monitoring Occasion) or it may follow a time offset after the last LP-WUS MO in a LP-WUS monitoring window (which may comprise multiple LP-WUS MOs). In an example, the WTRU may not report (e.g. prohibited from reporting) the CSI based on this CSI measurement RS in the CSI reporting occasion (e.g., first CSI reporting occasion after a “new” timer is started) if the CSI reporting occasion is less than a time offset after the CSI measurement RS. In an example, the WTRU may report (e.g. be required to report) the CSI based on the CSI measurement RS in the CSI reporting occasion if the CSI reporting occasion is a time offset after the CSI measurement RS or, alternatively, if the CSI reporting occasion is a time offset after the LP-WUS MO or the last LP-WUS MO of a LP-WUS monitoring window.

In an example, the CSI measurement RS may precede a time offset before a CSI reporting occasion. In an example, such CSI reporting occasion may be the first CSI reporting occasion after the “new” timer is started based on a received LP-WUS. In an example, the WTRU may measure (e.g. be required to measure) the CSI measurement RS if the CSI measurement RS is time offset after the LP-WUS MO (where the WTRU receives the LP-WUS) or time offset after the last LP-WUS MO of a LP-WUS monitoring window. For example, if the WTRU is able to receive a LP-WUS in the first LP-WUS MO of a LP-WUS monitoring window and the CSI measurement RS is time offset after this LP-WUS MO, the WTRU may measure (e.g. be required to measure) the CSI measurement RS and report it in the first CSI reporting occasion (e.g., first CSI reporting occasion after a “new” timer is started).

In an example, a CSI information may comprise, for example, at least one of: CQI (Channel Quality Information), L1-RSRP (Layer 1 Reference Signal Received Power), PMI (Precoding Matrix Indicator), CRI (CSI-RS Resource Indicator), SSBRI (SS/PBCH Resource Block Indicator), LI (Layer Indicator), and/or RI (Rank Indicator). In some examples, the CSI reported based on the CSI measurement RS above may comprise at least a subset of the CSI information. In an example, calculating/determining part of the CSI information may take more processing time or may require multiple measurement samples over time, hence, such part may not be reported in the CSI reporting occasion.

In an example, different WTRUs may support different offset times. Multiple offset times may be allowed to be implemented. Hence, in an example, the WTRU may indicate as a capability/capabilities (e.g. send capability information to, for example, a network entity) the offset times it prefers or requires for processing the CSI, waking up the MR when a LP-WUS is received, and transmitting the CSI report.

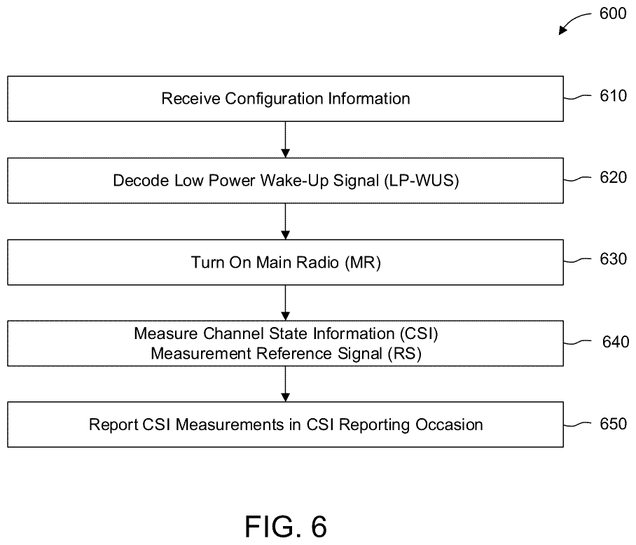

FIG. 6 shows an example method 600 of CSI reporting. A WTRU may receive configuration information 610. The configuration may comprise CSI measurement RS configuration information. The CSI measurement RS configuration information may include, for example, a resource parameter which may include an indication of a resource. The resource parameter may define the physical location (i.e., the location of a physical resource element) of the various CSI related reference signal. Types of the resources belonging to this category include: non-zero power (NZP)-CSI-RS resource, zero power (ZP)-CSI-RS resource, and interference management (IM) Resources. The CSI measurement and reporting configuration may include a resource set (ResourceSet). The Resource parameter may be an individual resources. The individual resources may belong to a specific group. If only one resource is to be used, it still may belong to a group. The group may be referred to as a ResourceSet. The CSI measurement and reporting configuration may include a CSI resource configuration (ResourceConfig), which may specify on what type of reference signal (e.g. NSP-CSI-RS-SSB, CSI-IM-Resource) is to be transmitted. It may also configure the types of the transmission (e.g. periodic, aperiodic, semipersistent). The CSI measurement and reporting configuration may include a CSI report configuration (ReportConfig), which may specify which CSI ResourceConfig is to be used for the measurement, which may be the mapping table between the measurement type and the corresponding CSI ResourceConfig ID. The CSI measurement and reporting configuration may include a periodicity and offset (CSI-ReportPeriodicityAndOffset), which may define the CSI reporting periodicity in number of slots and offset to determine the actual slot to transmit the report.

The CSI measurement RS configuration (i.e., a CSI measurement RS monitoring occasion or CSI measurement RS) or at least part of it (e.g., periodicity) may follow a LP-WUS monitoring configuration (e.g., periodicity). Alternatively or in addition, the CSI measurement RS configuration may be part of the LP-WUS monitoring configuration or the LP-WUS monitoring configuration may point or refer to or be associated with to a specific CSI measurement RS configuration (e.g., through an ID, such as a CSI ResourceConfig ID).

The configuration may comprise LP-WUS configuration information. The LP-WUS configuration information may comprise, for example, monitoring configuration information ; a subgroup ID; and a time offset to a timer start.

The configuration may comprise DRX configuration which may include, for example, a drx-onDurationTimer: the duration at the beginning of a DRX cycle; a drx-SlotOffset: the delay before starting the drx-onDurationTimer; a drx-InactivityTimer: the duration after the PDCCH occasion in which a PDCCH indicates a new UL, DL or SL transmission for the MAC entity; a drx-RetransmissionTimerDL (per DL HARQ process except for the broadcast process): the maximum duration until a DL retransmission is received; a drx-RetransmissionTimerUL (per UL HARQ process): the maximum duration until a grant for UL retransmission is received; a drx-LongCycleStartOffset: the Long DRX cycle and drx-StartOffset which defines the subframe where the Long and Short DRX cycle starts; a drx-HARQ-RTT-TimerDL (per DL HARQ process except for the broadcast process): the minimum duration before a DL assignment for HARQ retransmission is expected by the MAC entity; and a drx-HARQ-RTT-TimerUL (per UL HARQ process): the minimum duration before a UL HARQ retransmission grant is expected by the MAC entity.

The WTRU may monitor for, receive, and decode a low power wake-up signal (LP-WUS) 620 (e.g. LP-WUS YES as shown in FIG. 5). The WTRU's main radio (MR) may be in a sleep (e.g. deep sleep)/DRX mode or state. The WTRU may monitor/receive/decode the LP-WUS with the low power receiver (LR). The WTRU may monitor and receive the LP-WUS based on the LP-WUS monitoring configuration (i.e. receive the LP-WUS in a LP-WUS monitoring occasion (MO)).

The WTRU may turn on the MR 630. The WTRU may turn on the MR in response to an indication to wake up (e.g. in the decoded LP-WUS).

The WTRU may perform CSI measurements on a RS 640 (e.g. “RS for CSI measurement” in FIG. 5). The WTRU may perform CSI measurements based on the CSI measurement configuration information. The WTRU may perform CSI measurements using the MR. The CSI measurement RS may follow a time offset (e.g. “Second time offset” in FIG. 5) after the LP-WUS MO. The CSI measurement RS may follow a time offset after the last LP-WUS MO in a LP-WUS monitoring window, which may comprise multiple LP-WUS MOs). The CSI measurement RS may precede a CSI reporting occasion (e.g. “CSI reporting occasion” in FIG. 5) before (or while) a timer (e.g. new timer) for active time is ongoing or running. The CSI reporting occasion may be the first CSI reporting occasion after the new timer is started based on the received LP-WUS.

The WTRU may report CSI measurement information in the CSI reporting occasion 650. The WTRU may report CSI measurement information in the CSI reporting occasion based on a relationship or comparison of one of more time offsets to one or more events. The events may include for example a time of the LP-WUS monitoring occasion (that the WTRU received the LP-WUS), a time of the CSI measurement RS, and a time of the CSI reporting occasion.

In an example, the WTRU may report CSI measurement information, based on the CSI measurement RS, in the CSI reporting occasion (e.g. first CSI reporting occasion after the new timer is started) on a condition that the CSI reporting occasion is at least a time offset (e.g. “First time offset” in FIG. 5) after (i.e. more than) the LP-WUS MO (e.g. LP-WUS YES in FIG. 5, or after the last LP-WUS MO or the last LP-WUS MO of a LP-WUS monitoring window).

In an example, the WTRU may report CSI measurement information, based on the CSI measurement RS, in the CSI reporting occasion (e.g. first CSI reporting occasion after the new timer is started) on a condition that the CSI measurement RS is at least a time offset (e.g. “Second time offset” in FIG. 5) after (i.e. more than) the LP-WUS MO (i.e. where the WTRU received the LP-WUS) or after the last LP-WUS MO or the last LP-WUS MO of a LP-WUS monitoring window.

In an example, the WTRU may report CSI measurement information, based on the CSI measurement RS, in the CSI reporting occasion (e.g. first CSI reporting occasion after the new timer is started) on a condition that the CSI reporting occasion is at least a time offset (e.g. “Third time offset” in FIG. 5) after (i.e. more than) the CSI measurement RS.

In an example, the WTRU may report CSI measurement information, based on the CSI measurement RS, in the CSI reporting occasion (e.g. first CSI reporting occasion after the new timer is started) on a condition that the CSI measurement RS is at least a time offset (e.g. “Second time offset” in FIG. 5) after (i.e. more than) the LP-WUS MO and the CSI reporting occasion is at least a time offset (e.g. “Third time offset” in FIG. 5) after (i.e. more than) the CSI measurement RS.

The CSI information may comprise, for example, at least one of: CQI (Channel Quality Information), L1-RSRP (Layer 1 Reference Signal Received Power), PMI (Precoding Matrix Indicator), CRI (CSI-RS Resource Indicator), SSBRI (SS/PBCH Resource Block Indicator), LI (Layer Indicator), and/or RI (Rank Indicator). In some examples, the CSI reported based on the CSI measurement RS above may comprise at least a subset of the CSI information. In an example, calculating/determining part of the CSI information may take more processing time or may require multiple measurement samples over time, hence, such part may not be reported in the CSI reporting occasion.

A LP-WUS offset to the new timer start may be configured such that it accounts the WTRU maximum wake-up time before CSI measurement RS so that the WTRU may be able to measure with the MR always before the new timer defined active time. This may depend on a WTRU capability to be able to provide “one-shot” CSI measurement results.

The WTRU may measure and/or report only a subset of the CSI report based on this CSI measurement RS. This may depend or be based on for example, the processing time, and other CSI may be indicated as “out of range” and/or “outdated”.

The WTRU may indicate, as a capability/capabilities (e.g. send capability information to, for example, a network entity), the offset times it prefers or requires for processing the CSI, waking up the MR when a LP-WUS is received, and transmitting the CSI report (e.g. first time offset, second time offset, and third time offset).

A WTRU may receive one or more synchronization signals (SS). The SS may be based on one or more reference signals (RS). The SS may be based on one or more On-Off Keying (OOK) binary sequences, for example, in a time domain. In an example, the WTRU may receive the SS based on OOK-based receivers. The SS may be based on one or more OFDM sequences, for example, in a frequency domain. The SS may be based on binary sequences, where one or more OFDM sequences may overlay on the OOK symbols. In an example, the WTRU may receive the SS based on OFDM-based receivers. The WTRU may use the received SS for time and/or frequency synchronization. The WTRU may use the received SS for RRM measurements. The SS may carry one or more information. For example, the SS may carry all or part of information regarding a cell identification (ID).

In an example, the SS may be part of an SS/PBCH block (SSB). The SSB may include a primary synchronization signal (PSS), a secondary synchronization signal (SSS), and/or a physical broadcast channel (PBCH). For example, the WTRU may determine, be configured, and/or indicated to monitor, detect, receive, and/or measure the PSS, the SSS, or both.

In another example, the SS may be part of a Low-Power Synchronization Signal (LP-SS). For example, the LP-SS may be based on a low-power radio (LR). The LP-SS may be based on On-Off Keying (OOK) symbols forming binary sequences, where the WTRUs, for example with LP-WUS configurations, may use a LP-WUR (e.g., based on OOK receivers) to detect and receive a LP-SS. The LP-SS symbols may be overlaid with OFDM sequences, where the WTRUs, for example with LP-WUS configurations, may use a LP-WUR (e.g., based on OFDM receivers) to detect and receive a LP-SS. The WTRU may use the detected, received, and/or measured LP-SS for time and frequency synchronization with one or more of the serving or neighbor cell. The WTRU may use the detected, received, and/or measured LP-SS for RRM measurements. As such, the network may configure the LP-SS sequence associated to the serving cell in addition to a number of candidate LP-SS sequences associated with one or more neighbor cells, where the WTRU may measure RRM measurements accordingly, for the serving cell and configured neighbor cells, respectively.

In an example, the SS may be part of one or more received Low-Power Wake-Up Signals (LP-WUS). The SS may be a preamble received as part of a received LP-WUS, where the WTRU may use the received preamble for time and/or frequency synchronization and/or one or more LR measurements. For example, the WTRU may use the LR measurements for determining one or more quality parameters.

Herein, the term LP-SS may be used interchangeably with RS, SS, PSS, SSS, SSB, preamble, and/or LR measurements, and still be consistent with this disclosure.

A WTRU may determine, be configured, and/or indicated to measure one or more quality parameters based on one or more samples in a LR, within a determined, configured, and/or indicated time period. For example, the WTRU may measure the quality parameters based on LR while the WTRU is in an MR-OFF mode, that is when the WTRU is not in active time and the MR is in a sleep state. In an example, the time period for performing the LR measurements may be based on one or more C-DRX time cycle durations. In an example, the WTRU may measure one or more quality parameters including low-power reference-signal received power (LP-RSRP), low-power signal-to-noise and interference ration (LP-SINR), and low-power reference signal received quality (LP-RSRQ). The WTRU may receive the indications and/or configurations for measuring the quality parameters, for example, via a system information block (SIB), radio resource control (RRC), MAC-CE, or downlink control information (DCI).

In an embodiment, a WTRU may determine, be configured, and/or indicated to report one or more quality parameters that may be determined based on one or more LR measurements in one or more CSI reporting occasions, if one or more conditions are met or satisfied. For example, the WTRU may receive one or more configuration information and/or indications including one or more threshold values regarding the events and/or conditions to trigger reporting LR measurements in CSI reporting occasions, for example, via SIB, RRC, MAC-CE, or DCI. For example, the WTRU may report the LR measurements in a CSI reporting occasion, based on one or more of the following example conditions.

The WTRU may report the LR measurements in a CSI reporting occasion based on a “new “timer activation. For example, the WTRU may report the quality parameters measured based on LR measurements if the new timer is started and the WTRU is in active time.

The WTRU may report the LR measurements in a CSI reporting occasion based on CSI-RS measurements accuracy. In an example, the WTRU may determine that the measured parameters based on CSI-RS are not ready and/or not accurate. In an example, the WTRU may determine that the measured parameters based on CSI-RS are not ready and/or not accurate, if the number of samples required for the measurements based on the determined, configured, and/or indicated CSI-RSs are not enough and/or the number of measured samples are lower than a determined, (pre)configured, and/or indicated threshold.

The WTRU may report the LR measurements in a CSI reporting occasion based on outdated CSI-RS measurements. In an example, the WTRU may determine that the measured parameters based on CSI-RS are outdated. For example, the WTRU may determine that the measured parameters based on CSI-RS may be outdated, based on a determined, configured, and/or indicated parameter (e.g. “CSI validity time-window”). In an example, if the measurements were done before the CSI validity time-window the WTRU may consider the measurements as outdated. In another example, the WTRU may set a timer at the time of performing the measurements, where the timer may be set with the determined, configured, and/or indicated “CSI validity timer”. If the timer has elapsed, the WTRU may determine that the corresponding measurements may be outdated.

The WTRU may report the LR measurements in a CSI reporting occasion based on a delta of changes in LR measurements. In an example, the WTRU may determine that the changes in one or more of the measured quality parameters based on LR measurements is lower than a determined, indicated, and/or configured delta threshold. That is, the WTRU may determine that the LR measurement results did not change more than the corresponding delta threshold, for example during a determined, indicated, and/or configured time window. For example, the WTRU may determine that the delta of changes for one or more of the measured LP-RSRP, LP-RSRQ, or LP-SINR is less than the corresponding threshold, during the time window. In an example, the time window may be since the previous valid and/or accurate CSI measurement with the MR. The time window may be based on and/or a function of C-DRX cycle. The time-window may be during the MR-OFF and/or MR sleep mode.

In an embodiment, a WTRU may determine, be configured, and/or indicated to report LR measurements until accurate, valid, and/or up-to-date measured quality parameters based on CSI-RS are ready and available. In an example, the WTRU may determine, be configured, and/or indicated with the number of samples that needs to be measured based on CSI-RS, so that the measured parameters may be considered as accurate and/or valid. In an example, the WTRU may determine, be configured, and/or indicated with the time window after performing the measurements, during which the measured parameters based on CSI-RS may be considered as accurate and/or valid. The WTRU may receive one or more configuration information and/or indications for determining the validity and/or accuracy of the measurements based on the CSI-RS, for example, via SIB, RRC, MAC-CE, or DCI.

In an embodiment, the WTRU may report the LR measurements in a CSI report occasion, where the CSI report may include one or more (e.g., extra and/or new) indications. One or more of the following example indications may be included.

The CSI report may include an indication that LR measurements are reported. In an example, the WTRU may send one or more indications (e.g., as part of the CSI report) to indicate that the reported quality parameters may be based on LR measurements. That is, the WTRU may indicate that the reported quality parameters may not be based on MR measurements on CSI-RS resources. In an example, the WTRU may send such indication based on a flag indication, where a first value (e.g., value of one) may indicate that the reported quality parameters are based on LR measurements, and a second value (e.g., value of zero) may indicate that the reported quality parameters are based on MR measurements on CSI-RSs.

The CSI report may include an indication on the reported subset of parameters. In an example, the WTRU may send one or more indications (e.g., as part of the CSI report) to indicate that the reported LR measurements may include only a subset of expected quality parameters. That is, although the determined, (pre)configured, and/or indicated CSI report configurations may include a larger set of quality parameters to be reported, the WTRU may report only a subset of parameters based on LR measurements. In an example, the WTRU may only report LP-RSRP, LP-RSRQ, LP-SINR, and/or a combination of the parameters. The WTRU may indicate the subset of parameters that are being reported. In an example, the WTRU may send a flag indication per configured parameter, where a first value (e.g., value of zero) may indicate that the corresponding parameter is not reported, and a second value (e.g., value of one) may indicate that the corresponding parameter is reported. In an example, the WTRU may send an indication including a codepoint and/or index value, where the value of the codepoint and/or index value may correspond to a (pre)configured subset of parameters. For example, a first codepoint may indicate that a first subset of parameters is reported, and a second codepoint may indicate that a second subset of parameters is reported.

The CSI report may include LR measurement information. In an example, the WTRU may send indications on one or more information regarding the LR measurements. For example, the indication may include the LP-WUS, the transmission configuration indication (TCI)-state, the RS indexes, and/or the LP-SS index(es) that were used for measurements, the number of samples, and the time-window during which the LR measurement was performed.

The CSI report may include an indication on the accuracy of reported parameters. In an example, the WTRU may send indications on the accuracy of reported parameters. For example, the WTRU may indicate the one or more reported parameters that may be outdated, for example based on the last CSI-RS measurement. In an example, the WTRU may indicate the one or more reported parameters that may be inaccurate, for example based on not enough measured CSI-RS samples. The WTRU may indicate the subset of parameters that may be inaccurate and/or outdated. In an example, the WTRU may send a flag indication per configured parameter, where a first value (e.g., value of zero) may indicate that the corresponding reported parameter is not accurate or is outdated, and a second value (e.g., value of one) may indicate that the corresponding reported parameter is accurate and/or is up to date. In an example, the WTRU may send an indication including a codepoint and/or index value, where the value of the codepoint and/or index value may correspond to a (pre)configured subset of parameters. For example, a first codepoint may indicate that a first subset of parameters is inaccurate and/or outdated, and a second codepoint may indicate that a second subset of parameters is inaccurate and/or outdated.

The CSI report may include an indication on CSI measurement. In an example, the WTRU may send indications on whether the CSI measurement during an MR-ON mode was accomplished. The WTRU may send a flag indication indicating if the WTRU performed CSI-RS measurement during an MR-ON mode. In an example, this indication may be the same as the above indication of reporting LR based measurements in the CSI report. As such, the WTRU may send a flag indication, where a first value (e.g., value of zero) may indicate that the CSI measurement was performed and that the reports are based on CSI measurement with an MR-ON mode, and a second value (e.g., value of one) may indicate that the CSI measurement was not accomplished, and for example, that the CSI report is based on LR measurements in an MR-OFF mode.

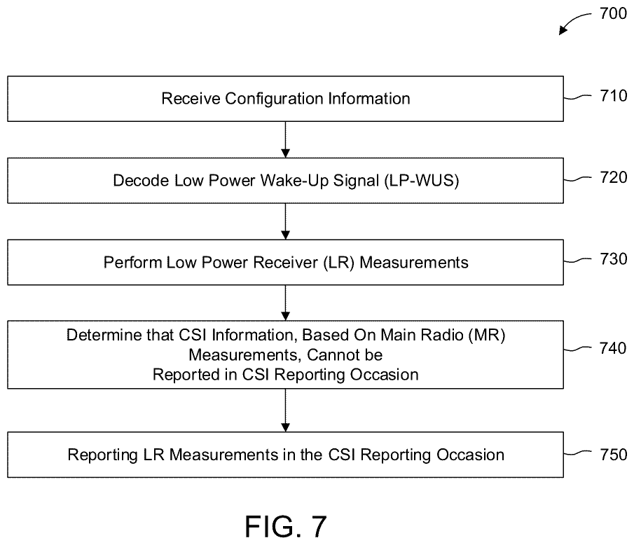

FIG. 7 shows an example method 700 of CSI reporting. A WTRU may receive configuration information 710. The configuration may comprise CSI measurement (RS) and reporting configuration information. The CSI measurement RS configuration information may include, for example, a resource parameter which may include an indication of a resource. The resource parameter may define the physical location (i.e., the location of a physical resource element) of the various CSI related reference signal. Types of the resources belonging to this category include: non-zero power (NZP)-CSI-RS resource, zero power (ZP)-CSI-RS resource, and interference management (IM) Resources. The CSI measurement and reporting configuration may include a resource set (ResourceSet). The Resource parameter may be an individual resources. The individual resources may belong to a specific group. If only one resource is to be used, it still may belong to a group. The group may be referred to as a ResourceSet. The CSI measurement and reporting configuration may include a CSI resource configuration (ResourceConfig), which may specify on what type of reference signal (e.g. NSP-CSI-RS-SSB, CSI-IM-Resource) is to be transmitted. It may also configure the types of the transmission (e.g. periodic, aperiodic, semipersistent). The CSI measurement and reporting configuration may include a CSI report configuration (ReportConfig), which may specify which CSI ResourceConfig is to be used for the measurement, which may be the mapping table between the measurement type and the corresponding CSI ResourceConfig ID. The CSI measurement and reporting configuration may include a periodicity and offset (CSI-ReportPeriodicityAndOffset), which may define the CSI reporting periodicity in number of slots and offset to determine the actual slot to transmit the report. The WTRU may receive the configuration information via a main radio (MR) receiver.

The CSI measurement RS configuration (i.e., a CSI measurement RS monitoring occasion or CSI measurement RS) or at least part of it (e.g., periodicity) may follow a LP-WUS monitoring configuration (e.g., periodicity). Alternatively or in addition, the CSI measurement RS configuration may be part of the LP-WUS monitoring configuration or the LP-WUS monitoring configuration may point or refer to or be associated with to a specific CSI measurement RS configuration (e.g., through an ID, such as a CSI ResourceConfig ID).

The configuration may comprise LP-WUS configuration information. The LP-WUS configuration information may comprise, for example, monitoring configuration information, a subgroup ID, and a time offset to a timer start.

The configuration may comprise DRX configuration which may include, for example, a drx-onDurationTimer: the duration at the beginning of a DRX cycle; a drx-SlotOffset: the delay before starting the drx-onDurationTimer; a drx-InactivityTimer: the duration after the PDCCH occasion in which a PDCCH indicates a new UL, DL or SL transmission for the MAC entity; a drx-RetransmissionTimerDL (per DL HARQ process except for the broadcast process): the maximum duration until a DL retransmission is received; a drx-RetransmissionTimerUL (per UL HARQ process): the maximum duration until a grant for UL retransmission is received; a drx-LongCycleStartOffset: the Long DRX cycle and drx-StartOffset which defines the subframe where the Long and Short DRX cycle starts; a drx-HARQ-RTT-TimerDL (per DL HARQ process except for the broadcast process): the minimum duration before a DL assignment for HARQ retransmission is expected by the MAC entity; and a drx-HARQ-RTT-TimerUL (per UL HARQ process): the minimum duration before a UL HARQ retransmission grant is expected by the MAC entity.

The WTRU may monitor for, receive, and decode a low power wake-up signal (LP-WUS) 720 (e.g. LP-WUS YES as shown in FIG. 5). The WTRU's main radio (MR) may be in a sleep (e.g. deep sleep)/DRX mode or state. The WTRU may monitor/receive/decode the LP-WUS with the low power receiver (LR). The WTRU may monitor and receive the LP-WUS based on the LP-WUS monitoring configuration (i.e. receive the LP-WUS in a LP-WUS monitoring occasion (MO)). The WTRU may activate the MR based on the LP-WUS. The WTRU's MR and LR may be separate receivers/transceivers or they may be implemented in a single receiver/transceiver.

The WTRU may perform low power receiver (LR) measurements 730. The LR measurements may be performed on a reference signal (RS). The reference signal may be a low power reference signal (LP-SS). The LR measurements may be performed while the WTRU is not in an active time and the MR is in a sleep state.

The WTRU may determine that CSI information, based on a MR measurement, cannot be reported in a CSI reporting occasion 740. The WTRU may determine that CSI information, based on a MR measurement, cannot be reported in the CSI reporting occasion based on a relationship or comparison of one of more time offsets to one or more events. The events may include for example a time of a LP-WUS monitoring occasion (that the WTRU received the LP-WUS), a time of the CSI measurement RS, and a time of the CSI reporting occasion.

In an example, the WTRU may determine that CSI information, based on a MR measurement, cannot be reported in the CSI reporting occasion on a condition that the time between the CSI reporting occasion and the LP-WUS MO (e.g. LP-WUS YES in FIG. 5, or after the last LP-WUS MO or the last LP-WUS MO of a LP-WUS monitoring window) is less than a time offset (e.g. “First time offset” in FIG. 5).

In an example, the WTRU may determine that CSI information, based on a MR measurement, cannot be reported in the CSI reporting occasion on a condition that the time between the CSI measurement RS and the LP-WUS MO (i.e. where the WTRU received the LP-WUS) or after the last LP-WUS MO or the last LP-WUS MO of a LP-WUS monitoring window is less than a time offset (e.g. “Second time offset” in FIG. 5).

In an example, the WTRU may determine that CSI information, based on a MR measurement, cannot be reported in the CSI reporting occasion on a condition that the time between the CSI reporting occasion and the CSI measurement RS is less than a time offset (e.g. “Third time offset” in FIG. 5).

The WTRU may report the LR measurements in the CSI reporting occasion 750. The WTRU may send a CSI report in the CSI occasion, based on the determining that the CSI information, based on a main radio (MR) measurement, is not to be reported in the CSI reporting occasion. The WTRU may send a CSI report in the CSI occasion, based on the measurements on the reference signal using the LR. The LR measurements may be reported in the CSI reporting occasion on a condition that the new timer is running (i.e. has been started) and the WTRU is in an active time. The WTRU may start the new timer an offset time after receiving the LP-WUS indication to start the timer. The WTRU may report the LR measurements in the CSI reporting occasion using the MR.

The WTRU may report the LR measurements until measurements are performed with the MR and the WTRU is ready to report the CSI information. The LR may keep measuring while the MR is active. The same LR measurement result from before the MR was activated may be reported in the CSI reporting occasions until the MR has measured CSI successfully (i.e., the LR does not measure anymore after the MR is activated).

The WTRU may include an indication in the report that the CSI information is based on LR measurements. The WTRU may indicate that the reported quality parameters are not based on MR measurements on CSI-RS resources. In an example, the WTRU may send such indication based on a flag indication, where a first value (e.g., value one) may indicate that the reported quality parameters are based on LR measurements, and a second value (e.g., value zero) may indicate that the reported quality parameters are based on MR measurements on CSI-RSs.

The WTRU may not include an indication in the report that the CSI information is based on LR measurements. The network may determine that the results are based on LR measurements based on a WTRU capability, indicated to the network, regarding the one or more time offsets (e.g. first time offset, second time offset, and/or third time offset).

The LR measurements may comprise a subset of MR CSI parameters (e.g., L1-RSRP only and/or SINR). The WTRU may send one or more indications (e.g., as part of the CSI report) to indicate that the reported LR measurements may include only a subset of expected quality parameters. That is, although the determined, (pre)configured, and/or indicated CSI report configurations may include a larger set of quality parameters to be reported, the WTRU may report only a subset of parameters based on LR measurements. In an example, the WTRU may only report LP-RSRP, LP-RSRQ, LP-SINR, and/or a combination of the parameters. The WTRU may indicate the subset of parameters that are being reported. In an example, the WTRU may send a flag indication per configured parameter, where a first value (e.g., value zero) may indicate that the corresponding parameter is not reported, and a second value (e.g., value one) may indicate that the corresponding parameter is reported. In another example, the WTRU may send an indication including a codepoint and/or index value, where the value of the codepoint and/or index value may correspond to a (pre)configured subset of parameters. For example, a first codepoint may indicate that a first subset of parameters is reported, a second codepoint may indicate that a second subset of parameters is reported.

The WTRU may send indications on one or more information regarding the LR measurements. For example, the indication may include the LP-WUS, the TCI-state, the RS indexes, and/or the LP-SS index(es) that were used for measurements, the number of samples, the time-window during which the LR measurement was performed.

The WTRU may indicate that the measurement are “outdated” an/or “out of range” or may use “outdated” measurements (e.g., previous measurement with MR) for other CSI except for L1-RSRP which may be reported based on the latest LR based measurements. For example, the WTRU may determine that the measured parameters based on CSI-RS may be outdated, based on a determined, configured, and/or indicated “CSI validity time-window”. In an example, if the measurements were done before the CSI validity time-window the WTRU may consider the measurements as outdated. In an example, the WTRU may set a timer at the time of performing the measurements, where the timer may be set with the determined, configured, and/or indicated “CSI validity timer”. In case the timer has elapsed, the WTRU may determine that the corresponding measurements may be outdated. the WTRU may determine that the measured parameters based on CSI-RS are not ready and/or accurate. In an example, The WTRU may determine that the measured parameters based on CSI-RS are not ready and/or accurate, in case the number of samples required for the measurements based on the determined, configured, and/or indicated CSI-RSs are not enough and/or the number of measured samples are lower than a determined, (pre)configured, and/or indicated threshold. The WTRU may determine that the changes in one or more of the measured quality parameters based on LR measurements is lower than a determined, indicated, and/or configured delta threshold. That is, the WTRU may determine that the LR measurement results did not change more than the corresponding delta threshold, for example during a determined, indicated, and/or configured time window. For example, the WTRU may determine that the delta of changes for one or more of the measured LP-RSRP, LP-RSRQ, or LP-SINR is less than the corresponding threshold, during the time window. In an example, the time window may be since the previous valid and/or accurate CSI measurement with MR. The time window may be based on and/or a function of C-DRX cycle. The time-window may be during the MR-OFF and/or MR sleep mode

The LR measurements may be reported in the CSI report if MR measurements are “too old” (e.g., based on a “CSI validity timer”) and/or if the LR measurement results did not change more than a threshold value (e.g., in terms of RSRP/RSRQ/SINR) during the MR sleep/since the previous CSI report/since the previous CSI measurement with the MR.

The WTRU may send indications on the accuracy of reported parameters. For example, the WTRU may indicate the one or more reported parameters that may be outdated, for example based on the last CSI-RS measurement. In another example, the WTRU may indicate the one or more reported parameters that may be inaccurate, for example based on not enough measured CSI-RS samples.

The WTRU may indicate the subset of parameters that may be inaccurate and/or outdated. In an example, the WTRU may send a flag indication per configured parameter, where a first value (e.g., value zero) may indicate that the corresponding reported parameter is not accurate or is outdated, and a second value (e.g., value one) may indicate that the corresponding reported parameter is accurate and/or is up to date. In another example, the WTRU may send an indication including a codepoint and/or index value, where the value of the codepoint and/or index value may correspond to a (pre)configured subset of parameters. For example, a first codepoint may indicate that a first subset of parameters is inaccurate and/or outdated, a second codepoint may indicate that a second subset of parameters is inaccurate and/or outdated, and so forth.

The WTRU may send indications on whether the CSI measurement during a MR-ON mode was accomplished. The WTRU may send a flag indication indicating if the WTRU performed CSI-RS measurement during the MR-ON mode. In an example, this indication may be the same as the above indication of reporting LR based measurements in the CSI report. As such, the WTRU may send a flag indication, where a first value (e.g., value 0) may indicate that the CSI measurement was performed and that the reports are based on CSI measurement with MR-ON mode and a second value (e.g., value 1) may indicated that the CSI measurement was not accomplished, and for example that the CSI report is based on LR measurements in MR-OFF mode.

Since the WTRU wake up time may be different depending on the “sleep state” of the MR, the WTRU may report whether the CSI measurement with the MR was performed or not. In an example, this indication may be the same as the above indication of reporting LR based measurements in the CSI report.

The method of FIG. 6 and FIG. 7 may be performed separately or may be combined.

In an example, when a LP-WUS triggers PDCCH monitoring (and the “new” timer start) and the LR indicates the MR to wake-up, an SRS (Sounding Reference Signal) may be triggered to be transmitted preceding the start of the new timer. For example, the SRS resource may immediately precede the start of the new timer (e.g., in the previous symbol(s)) or may be an offset before the start of the new timer (e.g., in terms of symbols, milliseconds, or slots). The SRS signal may be transmitted on the full bandwidth or on a configured sub band of the full bandwidth (e.g., the sub band may be configured by the network).

In an example, the opportunistic SRS may be triggered when specified and/or configured conditions are fulfilled. For example, if the WTRU is unable to report a proper CSI (e.g., based on condition described above), the WTRU may trigger the SRS transmission. The SRS transmission may be deterministic to the network based on the time offsets between LP-WUS MO(s), CSI measurement RS(s), and CSI reporting occasion(s), and the network may determine if the WTRU will transmit the SRS or not. In an example, the SRS is transmitted only if the channel conditions are good enough, (e.g., in terms of RSRP). Th network may configure the WTRU with an RSRP threshold below which the WTRU may not trigger the SRS transmission after LP-WUS wake-up regardless of if it may report the CSI or not. In an example, the SRS triggering may depend on the frequency band the WTRU is operating and/or if the system is operating in a TDD mode.

In an example, the WTRU may be configured with at least two different SRS configurations which may be used based on a condition. For example, if the WTRU is unable to report CSI in the first reporting occasion following the start of the new timer, the WTRU may use the first one of the at least two different SRS configurations, whereas if the WTRU is able to report the CSI, it may use the second one of the at least two different SRS configurations. For example, the first one of the at least two different SRS configurations may comprise a wideband SRS which spans through the whole bandwidth and the network may measure the channel through the whole bandwidth while the second one of the at least two different SRS configurations may comprise a sub-band SRS.

In an embodiment, a WTRU may determine whether the WTRU is ready to report CSI. The determination may be based on one or more of the following.

The WTRU may determine whether the WTRU is ready to report CSI based on whether the CSI measurement is ready or not for the report (e.g., the first CSI reporting occasion after waking up LP-WUS). The WTRU may determine whether the WTRU is ready to report CSI based on whether CSI generation is ready or not for the report (e.g., the first CSI reporting occasion after waking up LP-WUS). The WTRU may determine whether the WTRU is ready to report CSI based on whether the generated CSI is valid or not.

For example, the determination of whether CSI measurement/generation is ready may be based on one or more of the following

The determination of whether CSI measurement/generation is ready may be based on a time offset between the RS measurement and LP-WUS reception. For example, if time offset between the RS measurement and LP-WUS reception is larger than a first threshold (e.g., predefined/configured), the WTRU may determine that the WTRU is able to report CSI. Otherwise, the WTRU may determine that the WTRU is not able to report CSI (e.g., based on the measurement).

The determination of whether CSI measurement/generation is ready may be based on a time offset between the RS measurement and the CSI reporting instance (e.g., PUCCH/PUSCH). For example, if time offset between the RS measurement and the CSI reporting is larger than a second threshold (e.g., predefined/configured), the WTRU may determine that the WTRU is able to report CSI. Otherwise, the WTRU may determine that the WTRU is not able to report CSI (e.g., based on the measurement).

The determination of whether CSI measurement/generation is ready may be based on whether the RS is transmitted after the MR wake up. For example, if a number of RS transmission for CSI measurement after the MR wake up (e.g., based on receiving a LP-WUS) is larger than a third threshold, the WTRU may determine that the WTRU is able to report CSI. Otherwise, the WTRU may determine that the WTRU is not able to report CSI (e.g., based on the measurement).

In an example, the determination of whether generated CSI is outdated may be based on one or more of the following.

The determination of whether generated CSI is outdated may be based on a time offset between the RS measurement and the LP-WUS reception. For example, if a time offset between the RS measurement and the LP-WUS reception is smaller than a fourth threshold (e.g., predefined/configured), the WTRU may determine that the generated CSI is valid. Otherwise, the WTRU may determine that the generated CSI is outdated.

The determination of whether generated CSI is outdated may be based on a time offset between the RS measurement and the CSI reporting instance (e.g., PUCCH/PUSCH). For example, if a time offset between the RS measurement and the CSI reporting is smaller than a fifth threshold (e.g., predefined/configured), the WTRU may determine that the generated CSI is valid. Otherwise, the WTRU may determine that the generated CSI is outdated.

The determination of whether generated CSI is outdated may be based on a time offset between the CSI generation instance and the CSI reporting instance (e.g., PUCCH/PUSCH). For example, if a time offset between the CSI generation and the CSI reporting is smaller than a sixth threshold (e.g., predefined/configured), the WTRU may determine that the generated CSI is valid. Otherwise, the WTRU may determine that the generated CSI is outdated.

In an embodiment, the WTRU may indicate (e.g., to a gNB) the determination. The indication may be an explicit indication. For example, the WTRU may indicate explicitly whether the information is ready or not. For example, one bit information may indicate the CSI is not ready to be reported (e.g., by indicating a value of zero) or ready to be reported (e.g., by indicating a value of one). The indication may be a signal/resource based indication. For example, the WTRU may indicate whether the information is ready or not based on UL signals and/or resources. For example, the WTRU may transmit a first signal if the WTRU is ready to report and a second signal if the WTRU is not ready to report. In an example, the WTRU may transmit an UL signal in a first resource if the WTRU is ready to report and may transmit the UL signal in in a second resource if the WTRU is not ready to report.

In an embodiment, UL signals and/or resources may be one or more of: PUCCH, PUSCH, medium access control (MAC) control element (CE), physical random access channel (PRACH), SRS, UL demodulation reference signal (DMRS), and UL phase tracking reference signal (PTRS).

A WTRU may be prepared to report CSI more infrequently during DRX.

In an embodiment, the WTRU may be configured to be prepared to report CSI for every Xth LP-WUS MO cycle or every Yth CSI reporting cycle. The WTRU may have to perform a measurement such that measurement requirements are fulfilled for every Xth LP-WUS MO/Yth CSI reporting cycle and hence possible reporting occasion.

In an example, the WTRU may measure for a CSI report for every 2^{nd}/3^{rd} LP-WUS MO cycle and report the most frequent CSI whenever a LP-WUS wakes up the WTRU. Since this may be a network configuration, the network knows how “old” the CSI is for any LP-WUS occasion where it may wake up the WTRU.

In an example, the requirement may also be defined in the number of periodicities of the CSI measurement RS. While in active time (e.g., based on the new timer), the WTRU may assume the CSI measurement RS is available in all configured occasions, or at least as much that the measurement requirements are fulfilled. While not in active time (and monitoring for LP-WUS), the WTRU may assume the CSI measurement RS is available for measurement for every Yth RS occasion.

In an example, the periodicity for “being prepared” to report CSI may depend on the data activity. For example, the WTRU may measure for reporting CSI more frequently after new data has been received, while not in DRX active time (e.g., after an inactivity timer expiry). For example, the WTRU may be prepared to report CSI for every 2^{nd}/3^{rd} LP-WUS MO/CSI reporting occasion after the data activity. For example, after a timer expiry, the WTRU may start measuring more infrequently (e.g., the WTRU may be prepared to report CSI for every 5th LP-WUS MO/CSI reporting occasion).

In an example, for a change in LR measurements (e.g., in terms of RSRP) more than a configured threshold level or amount, the MR may be triggered to measure/update CSI more frequently.

If there was a CSI-RS to measure after the LP-WUS in a measurement window, the WTRU may measure and report based on that. If there is more than one RS in the window, the WTRU may use the latest RS which meets the minimum processing time requirement

In an example, the WTRU may be configured with a second periodicity for CSI reporting while the WTRU is monitoring for LP-WUS while the first periodicity for CSI reporting is applied while the WTRU is in active time (e.g., the new timer is running). In an example, the second periodicity may be configured in the number of the first periodicities (e.g., every 2^{nd}, 3^{rd}). As an example, the WTRU may be able to report CSI based on the second periodicity even though the WTRU is monitoring for LP-WUS with LP-WUR/LR (i.e., that means that the WTRU has to perform required measurements (e.g., up to WTRU implementation) so that it may report the CSI if a LP-WUS wakes up the WTRU for PDCCH monitoring (i.e., the new timer is started)).

In an example, the second periodicity for CSI reporting may follow the LP-WUS MO periodicity and may be a number of the LP-WUS MO periodicities (e.g., every 2^{nd}, 3^{rd}, . . . ). As an example, the WTRU may be able to report CSI based on the second periodicity (i.e., the WTRU has to perform required measurements (e.g., up to WTRU implementation) so that it may report the CSI if the LP-WUS wakes up the WTRU for PDCCH monitoring (i.e., the new timer is started) in such an occasion the WTRU CSI reporting is required).

In an example, the WTRU may perform CSI measurements as in the above two examples and reports the most recently measured CSI (i.e., the most frequent) in case a LP-WUS wakes up the WTRU for PDCCH monitoring. The network knows that the WTRU has a CSI (e.g., from a previous LP-WUS occasion cycle) and may perform more conservative scheduling to account any changes after the measurements.

A LP-WUS may indicate to measure CSI. A WTRU may prepare CSI reports based on a prior indication for preparing to transmit CSI.

Transmitting CSI reports by a WTRU monitoring for a LP-WUS (e.g., WTRU is monitoring for one or more LP signal (e.g., LP-WUS, LP-SS) via an LR while the MR is in a power saving state) may be conditioned on a WTRU receiving an indication to wake-up the MR (e.g., for monitoring and receiving PDCCHs) during reporting resources associated with CSI reports. For example, if reporting resources of a CSI report is associated with a timer (e.g., drx-onDurationTimer or a new timer triggered by a LP-WUS) triggered by a LP-WUS for PDCCH monitoring (e.g., uplink resources (e.g., PUCCH resources) for the reports are located during active time by the timer) the WTRU may transmit the CSI report. To make sure CSI reports are ready (e.g., measure resources associated with CSI reports, and reports are generated) to be transmitted in configured reporting resources, the WTRU may perform one or more of the following embodiments/steps/procedures.

In an embodiment, a WTRU may receive an indication from a network entity, for example, a gNB (e.g., in a LP-WUS, PDCCH, or MAC-CE) indicating to be prepared to transmit CSI reports associated with one or more future reporting resources or one or more future occurrences of LP-WUS MOs. Here, a CSI report may be defined to be associated with a an LP-WUS MO if transmitting the CSI report is conditioned on receiving a LP-WUS in the LP-WUS MO (e.g., reporting resources of the CSI report are located during active time of the MR (e.g., active time of MR for PDCCH monitoring) triggered by a LP-WUS). Preparing to transmit a CSI report may be associated with one or more of, waking-up (activating/switching on the MR) the MR and measuring resources (e.g., CSI-RSs, SSBs) associated with the CSI report and generating or processing the CSI report. For example, the WTRU may receive an indication via a LP-WUS indicating to prepare to transmit (e.g., all) CSI reports of which reporting resources are configured during one or more future occurrences of one or more timers (e.g., timers (e.g., drx-onDurationTimer) configured to be triggered by an LP-WUS for PDCCH monitoring). The WTRU may commence preparing (e.g., measuring resources associated with CSI reports and generating CSI reports) to transmit CSI reports prior to receiving and/or decoding the LP-WUS which may include an indication for triggering timers during which reporting resources of CSI reports are located.

A WTRU may determine CSI reports to be prepared for transmitting respective reports based on one or more of the following.

In an example, a WTRU may, based on the indication, prepare to transmit CSI reports for CSI reports of which reporting resources are located within a preconfigured (e.g., via RRC signaling, MAC-CE indication, DCI indication) duration (denoted by t_measureCSI). t_measureCSI may be configured in terms of one of the following: number of DRX cycles; number of slots, frames, ms, number of occurrences of a timer (e.g., drx-onDurationTimer).

In an example, the WTRU may, based on the indication, prepare to transmit CSI reports for CSI reports associated with a preconfigured (e.g., via RRC signaling, MAC-CE indication, DCI indication) number of occurrences of LP-WUS-MOs/LOs. For example, the WTRU may prepare to transmit CSI reports of which reporting resources are configured during one or more timers associated with the next LP-WUS MO/LO (e.g., timers triggered for PDCCH monitoring based on LP-WUSs received in the next LP-WUS MO/LO).

In an example, a WTRU may, based on the indication, prepare to transmit CSI reports until a 2^{nd} indication (e.g., via a LP-WUS indication, DCI indication, MAC-CE indication) is received.

In an example, a WTRU may, based on the indication, prepare to transmit CSI reports until a preconfigured (e.g., via RRC signaling, MAC-CE indication, DCI indication) number (e.g., 1) of CSI reports are transmitted.

In an example, a WTRU may, based on the indication, prepare to transmit CSI reports for CSI reports associated with a preconfigured (e.g., via RRC signaling, MAC-CE indication, DCI indication) types (e.g., periodic, semi-persistent) of report configurations.

In an example, a WTRU may, based on the indication, prepare to transmit CSI reports for CSI reports associated with a preconfigured (e.g., via RRC signaling, MAC-CE indication, DCI indication) report quantity (e.g., CRI and L1-RSRP).

In an example, a WTRU may, based on the indication, prepare to transmit CSI reports for CSI reports associated with a preconfigured (e.g., via RRC signaling, MAC-CE indication, DCI indication) set of report configurations (CSI-ReportConfig).

In an embodiment, a WTRU may transmit a CSI report that may conditioned on the WTRU receiving a wake-up (e.g., in a LP-WUS) indication for activating the MR (e.g., for PDCCH monitoring) during reporting resources associated with the CSI report. For example, if the WTRU receives a LP-WUS triggering a timer (e.g., drx-onDurationTimer for PDCCH monitoring within on duration of a DRX cycle, a timer triggered for PDCCH monitoring by a LP-WUS outside DRX on duration of a DRX cycle) during which reporting resources of a CSI report is located, the WTRU may transmit the CSI report. In another example, if the MR is not active during reporting resources of a CSI report, the WTRU may skip transmitting the CSI report on the configured reporting resources.

A WTRU may transmit CSI reports during a 1^{st} type on duration based on activating a MR during a 2^{nd} type of on duration.

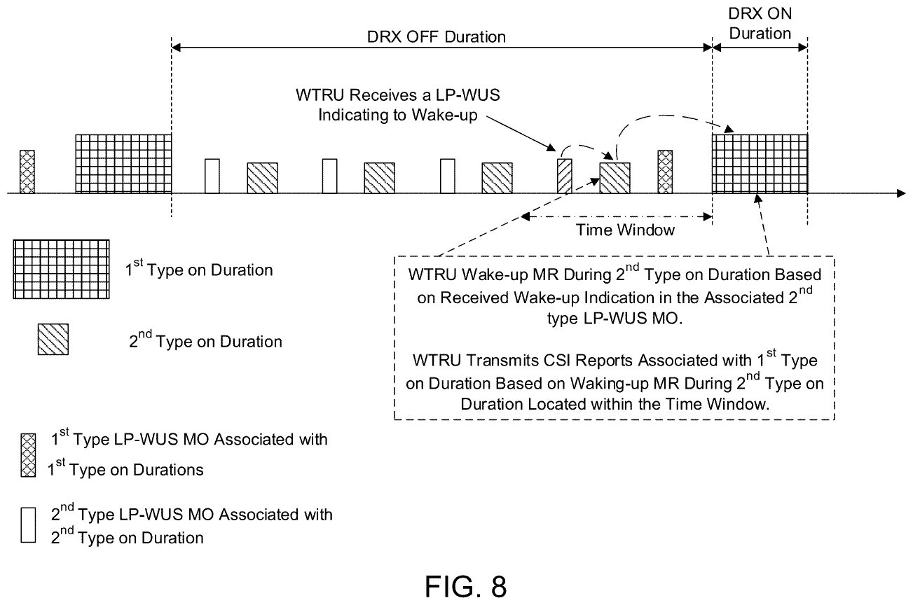

FIG. 8 shows an example of a 1^{st} type and 2^{nd} type on durations and 1^{st} type and 2^{nd} type LP-WUS MOs. A WTRU may be configured with two types of on durations (e.g., on duration for PDCCH monitoring when the WTRU operates with a DRX (e.g., C-DRX) configuration). For example, the WTRU may be configured with a 1^{st} type on duration, which may be associated (e.g., located within or co-located) with a DRX ON duration of a DRX configuration. The WTRU may be configured with a 2^{nd} type on duration which may be associated with (e.g., located during DRX OFF durations) a DRX OFF duration (outside a DRX ON duration), as shown in FIG. 8. Each 1st type on duration may be associated with a 1^{st} type LP-WUS MO. For example, a 1^{st} type LP-WUS MO may be associated with a 1^{st} type on duration which may be located with a preconfigured (e.g., via RRC signaling, MAC-CE indication, or DCI indication) offset from (e.g., starting point of) the 1^{st} type on duration. Each 2^{nd} type on duration may be associated with a 2^{nd} type LP-WUS MO. For example, a 2^{nd} type LP-WUS MO may be associated with a 2^{nd} type on duration located with a preconfigured (e.g., via RRC signaling, MAC-CE indication, or DCI indication) offset from (e.g., starting point of) the 2^{nd} type on duration, The WTRU may perform LP-WUS monitoring during which the WTRU may monitor for one or more types of LP signals (e.g., LP-WUS, LP-SS) via a LR while keeping the MR in a power saving state. If the WTRU receives an LP-WUS addressed to the WTRU (e.g., with a WTRU ID or a subgroup ID), the WTRU may wake-up its MR (e.g., for PDCCH monitoring) during an on duration associated with the LP-WUS MO the LP-WUS addressed to the WTRU was received. For example, if the WTRU receives a wake-up indication for the WTRU in a 1^{st} type LP-WUS MO, the WTRU may wake-up MR (e.g., for PDCCH monitoring, transmitting CSI reports associated (e.g., reporting resources (e.g., PUCCH resources) are located within the on duration) with the on duration) during the 1^{st} type on duration associated with the LP-WUS MO. In another example, if the WTRU receives a wake-up indication for the WTRU in a 2^{nd} type LP-WUS MO, the WTRU may wake-up its MR (e.g., for PDCCH monitoring, transmitting CSI reports associated (e.g., reporting resources are located within the on duration) with the on duration) during the 2^{nd} type on duration associated with the 2^{nd} type LP-WUS MO.

In an embodiment, a WTRU may be preconfigured (e.g., via RRC signaling, MAC-CE indication, or DCI indication) to transmit CSI reports associated with a 1^{st} type on duration based on MR activation during at least one of the 2^{nd} type on durations located within a time window associated with the 1^{st} type on duration. For example, the time window may be located immediately prior to the 1^{st} type on duration. In an example, the WTRU may receive configuration of a time window in terms of symbols, slots, frames, or ms from the starting point (e.g., starting symbol) of a 1^{st} type on duration.

If the WTRU receives a LP-WUS (e.g., indicating to wake-up the MR) in a 1^{st} type LP-WUS MO, the WTRU may turn on the MR and monitor for and receive PDCCHs during the 1^{st} type on duration associated with the 1^{st} type LP-WUS MO. For example, the WTRU may trigger a preconfigured (e.g., via RRC signaling, MAC-CE indication, or DCI indication)1^{st} timer associated with PDCCH monitoring in the 1^{st} type on duration and monitor for and receive PDCCHs while the 1^{st} timer is running. If the WTRU is configured with one or more CSI reports associated (e.g., reporting resources (e.g., PUCCH resources) of CSI reports are located within 1^{st} type on duration MR is activated) with the 1^{st} type on duration in which the MR is activated, the WTRU may transmit associated CSI reports to the network entity (e.g. gNB).

If the WTRU is not waken-up during a 1^{st} type on duration (e.g., no wake-up indication was received during LP-WUS MO associated with 1^{st} type on duration) but the WTRU was waken-up during at least one of the 2^{nd} type on durations located within the preconfigured time window associated with the 1^{st} type on duration, the WTRU may transmit one or more CSI reports associated with the 1^{st} type on duration. For example, the WTRU may measure resources (e.g., CSI-RSs, SSBs) associated with the configured CSI reports, process CSI measurements, and transmit CSI reports in the configured resources located during the 1^{st} type on duration.

In an example, the network may configure a WTRU (e.g. send configuration information) with a short DRX cycle on top of (e.g. in addition to) the long DRX cycle and the LP-WUS configuration. For example, if the LP-WUS triggers PDCCH monitoring during the “new” timer run and the WTRU performs one or more of the CSI/SRS reporting procedures, upon expiry of the new timer or, for example, upon receiving a DRX Command MAC CE, the WTRU may apply (e.g. determine to apply) the short DRX cycle. In such a case, when the WTRU is configured to report CSI/L1-RSRP during drx-onDurationTimer occasions, the WTRU may determine the drx-onDurationTimer occasions based on the short DRX cycle and report CSI/L1-RSRP according to the short DRX cycle.

In an example, the network may indicate to the WTRU (e.g. send an indication) that the CSI reporting is not imminent (e.g., while the “new” timer is running) and the WTRU does not need to be prepared with the MR to report CSI. In an example, the WTRU may prepare to report only LR measurements as part of the CSI in case the network indication is received. In an example, a timer is started upon the network indication and the WTRU may rely on LR measurements, in the case of CSI reporting, while the timer is running and may apply the procedures as defined herein after the timer has expired.

In an example, the network indication may be a MAC CE or provided in a DCI or other signaling means. In an example, the network indication may be the long DRX command MAC CE.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use by a wireless transmit/receive unit (WTRU) for channel state information (CSI) reporting, the method comprising:
receiving configuration information, wherein the configuration information comprises CSI measurement and reporting configuration information and low power wake-up signal (LP-WUS) configuration information, wherein the CSI measurement and reporting configuration information indicates a CSI reporting occasion, and wherein the LP-WUS configuration information indicates LP-WUS monitoring occasions (MOs);
receiving and decoding a LP-WUS, using a low power wake-up receiver (LR), in a LP-WUS MO;
performing measurements on a reference signal (RS) using the LR;
determining that CSI information, based on a main radio (MR) measurement, is not to be reported in the CSI reporting occasion; and
sending a CSI report in the CSI reporting occasion, based on the determining that CSI information is not to be reported in the CSI reporting occasion, wherein the CSI report is based on the measurements on the reference signal using the LR, when the WTRU is in an active time.

2. The method of claim 1, wherein the determining that CSI information, based on a main radio (MR) measurement, is not to be reported in a CSI reporting occasion is based on a time between a time of the CSI reporting occasion and a time of the LP-WUS MO being less than a first time offset value.

3. The method of claim 1, wherein the determining that CSI information is not to be reported, based on a main radio (MR) measurement, in a CSI reporting occasion is based on a time between a time of a CSI measurement RS and a time of the LP-WUS MO being less than a second time offset value.

4. The method of claim 1, wherein the determining that CSI information, based on a main radio (MR) measurement, is not to be reported in a CSI reporting occasion is based on a time between a time of the CSI reporting occasion and a time of a CSI measurement RS being less than a third time offset value.

5. The method of claim 1, further comprising:
sending subsequent CSI reports, based on LR measurements, until the WTRU measures CSI information with the MR and is ready to report CSI information, based on MR measurements.

6. The method of claim 1, further comprising:
sending an indication that the CSI report is based on LR measurements.

7. The method of claim 1, wherein the CSI report, based on the measurements on the reference signal using the LR, comprises a subset of parameters of MR CSI parameters, wherein the CSI report, based on the measurements on the reference signal using the LR, comprises at least a layer 1 reference signal received power (L1-RSRP).

8. The method of claim 7, wherein the L1-RSRP parameter is based on a most recent LR measurement and other parameters in the CSI report are based on outdated measurements, wherein the outdated measurement are based on previous MR measurements.

9. The method of claim 1, wherein the sending the CSI report, based on the measurements on the reference signal using the LR, is based on an expiration of a CSI validity timer.

10. The method of claim 1, wherein the sending the CSI report, based on the measurements on the reference signal using the LR, is based on results of LR measurements changing less than a threshold amount during a sleep cycle of the MR or since a previous CSI report or since a previous CSI measurement with the MR.

11. A wireless transmit/receive unit (WTRU) configured to report channel state information (CSI), the WTRU comprising:
a main radio (MR) transceiver;
a low power wake-up radio (LR) transceiver; and
a processor, wherein:
the MR transceiver is configured to receive configuration information, wherein the configuration information comprises CSI measurement and reporting configuration information and low power wake-up signal (LP-WUS) configuration information, wherein the CSI measurement and reporting configuration information indicates a CSI reporting occasion, and wherein the LP-WUS configuration information indicates LP-WUS monitoring occasions (MOs);
the LR transceiver is configured to receive and decode a LP-WUS in a LP-WUS MO;
the LR transceiver and the processor are configured to perform measurements on a reference signal (RS);
the processor is configured to determine that CSI information, based on measurements of the MR transceiver, is not to be reported in the CSI reporting occasion based on a relationship of one or more time offsets to one or more events; and
the MR transceiver is configured to send a CSI report in the CSI reporting occasion, based on the determining that CSI information is not to be reported in the CSI reporting occasion, wherein the CSI report is based on the measurements on the reference signal using the LR transceiver, when the WTRU is in an active time.

12. The WTRU of claim 11, wherein the determination that CSI information, based on measurements of the MR transceiver, is not to be reported in a CSI reporting occasion is based on a time between a time of the CSI reporting occasion and a time of the LP-WUS MO being less than a first time offset value.

13. The WTRU of claim 11, wherein the determination that CSI information, based on measurements of the MR transceiver, is not to be reported in a CSI reporting occasion is based on a time between a time of a CSI measurement RS and a time of the LP-WUS MO being less than a second time offset value.

14. The WTRU of claim 11, and wherein the determination that CSI information, based on measurements of the MR transceiver, is not to be reported in a CSI reporting occasion is based on a time between a time of the CSI reporting occasion and a time of a CSI measurement RS being less than a third time offset value.

15. The WTRU of claim 11, wherein
the MR transceiver is further configured to send subsequent CSI reports, based on LR measurements, until the WTRU measures CSI information with the MR transceiver and is ready to report CSI information, based on measurement of the MR transceiver.

16. The WTRU of claim 11, wherein:
the MR transceiver is further configured to send an indication that the CSI report is based on LR measurements.

17. The WTRU of claim 11, wherein the CSI report, based on the measurements on the reference signal using the LR transceiver, comprises a subset of parameters of MR CSI parameters, wherein the CSI report, based on the measurements on the reference signal using the LR transceiver, comprises at least a layer 1 reference signal received power (L1-RSRP).

18. The WTRU of claim 17, wherein the L1-RSRP parameter is based on a most recent LR measurement and other parameters in the CSI report are based on outdated measurements, wherein the outdated measurement are based on previous MR measurements.

19. The WTRU of claim 11, wherein the sending the CSI report, based on the measurements on the reference signal using the LR, is based on an expiration of a CSI validity timer.

20. The WTRU of claim 11, wherein the sending the CSI report, based on the measurements on the reference signal using the LR transceiver, is based on results of LR measurements changing less than a threshold amount during a sleep cycle of the MR or since a previous CSI report or since a previous CSI measurement with the MR.
